(19) United States
(12) Patent Application Publication
(10) Pub. No.: US 2012/0110244 A1
(43) Pub. Date: May 3, 2012

(54) COPYBACK OPERATIONS

(75) Inventors: Peter Feeley, Boise, ID (US); Jui-Yao Yang, San Jose, CA (US); Mahmood Mozaffari, Los Gatos, CA (US); Siamack Nemazie, Los Altos Hills, CA (US)

(73) Assignee: MICRON TECHNOLOGY, INC., Boise, ID (US)

(21) Appl. No.: 13/046,427

(22) Filed: Mar. 11, 2011

Related U.S. Application Data
(60) Provisional application No. 61/409,375, filed on Nov. 2, 2010.

(51) Int. Cl. G06F 12/16; G06F 12/00

(52) U.S. Cl. 711/103; 711/162; 711/E12.008; 711/E12.103

(57) ABSTRACT

Methods and systems for copyback operations are described. One or more methods include reading data from a first memory unit of a memory device responsive to a copyback command, performing signal processing on the data using a signal processing component local to the memory device, and programming the data to a second memory unit of the memory device.

This application is a Non-Provisional Application of U.S. Provisional Application No. 61/409,375, filed Nov. 2, 2010, the entire specification of which is herein incorporated by reference.

### TECHNICAL FIELD

The present disclosure relates generally to semiconductor memory devices, methods, and systems, and more particularly, to methods, devices, memory controllers, and systems for copyback operations.

### BACKGROUND

Memory devices are typically provided as internal, semiconductor, integrated circuits in computers or other electronic devices. There are many different types of memory including volatile and non-volatile memory. Volatile memory can require power to maintain its information and includes random-access memory (RAM), dynamic random access memory (DRAM), and synchronous dynamic random access memory (SDRAM), among others. Non-volatile memory can provide persistent information by retaining stored information when not powered and can include NAND flash memory, NOR flash memory, read only memory (ROM), Electrically Erasable Programmable ROM (EEPROM), Erasable Programmable ROM (EPROM), phase change random access memory (PCRAM), resistive random access memory (RRAM), and magnetic random access memory (MRAM), such as spin torque transfer random access memory (STT RAM), among others.

Memory devices can be combined together to form a solid state drive (SSD). A solid state drive can include non-volatile memory (e.g., NAND flash memory and NOR flash memory), and/or can include volatile memory (e.g., DRAM and SRAM), among various other types of non-volatile and volatile memory. An SSD can be used to replace hard disk drives as the main storage device for a computer, as the solid state drive can have advantages over hard drives in terms of performance, size, weight, ruggedness, operating temperature range, and power consumption. For example, SSDs can have superior performance when compared to magnetic disk drives due to their lack of moving parts, which may avoid seek time, latency, and other electro-mechanical delays associated with magnetic disk drives. SSD manufacturers can use non-volatile flash memory to create flash SSDs that may not use an internal battery supply, thus allowing the drive to be more versatile and compact.

An SSD can include one or more discrete memory packages, and one or more of the memory packages can be multi-chip packages (MCPs). A MCP can include a number of memory dies or chips thereon, which can be referred to as logical units (LUNs). As used herein, “a number of” something can refer to one or more of such things. As an example, the memory chips and/or dies associated with a MCP can include a number of memory arrays along with peripheral circuitry. The memory arrays can include memory cells organized into a number of physical blocks, with each of the physical blocks capable of storing multiple pages of data.

Various memory systems include a system controller to perform operations such as erase operations, program operations, and read operations, for example. In addition, some memory systems support “copyback” operations. A copyback operation can involve moving data of a first page (e.g., a source page) to a second page (e.g., a target page, which may sometimes be referred to as a destination page). Performing a copyback operation can include a copyback read operation, a copyback program operation, and a copyback program verify operation. A copyback read operation can include reading data stored in a source page and storing it in a page buffer. A copyback program operation can include reprogramming the data stored in the page buffer to the target page. In some instances, the data stored in the page buffer can be moved (e.g., transferred) directly to the target page without reading the data out of the page buffer. The copyback program verify operation can then be used to confirm whether the data is correctly programmed to the target page.

Memory systems supporting copyback operations can include signal processing (e.g., error correction code and/or other data recovery algorithms) components such as error correction code (ECC) circuitry. The complexity of ECC circuitry (e.g., the number of logic gates required to implement adequate error correction) increases with advancing manufacturing technology, for example. Increased ECC circuit complexity can lead to drawbacks such as increasing the size of memory system controllers that include ECC functionality, among other drawbacks.

### BRIEF DESCRIPTION OF THE DRAWINGS

FIG. 1 is a block diagram of a computing system in accordance with one or more embodiments of the present disclosure.

FIG. 2 is a block diagram of a portion of a memory system that can perform copyback operations in accordance with the prior art.

FIG. 3 is a block diagram of a portion of a memory system that can perform copyback operations in accordance with the prior art.

FIG. 4 is a block diagram of a portion of a memory system that can perform copyback operations in accordance with one or more embodiments of the present disclosure.

FIG. 5 is a block diagram of a portion of a memory system in accordance with prior art.

FIG. 6 is a block diagram of a portion of a memory system in accordance with one or more embodiments of the present disclosure.

FIG. 7 is a block diagram of a portion of a memory system in accordance with one or more embodiments of the present disclosure.

### DETAILED DESCRIPTION

The present disclosure includes methods, devices, memory controllers, and systems for performing copyback operations. One or more methods include reading data from a first memory unit of a memory device responsive to a copyback command, performing signal processing on the data using a signal processing component local to the memory device, and programming the data to a second memory unit of the memory device.

Embodiments of the present disclosure can provide various benefits such reducing bus load during copyback operations, reducing the time used for data recovery operations, such as ECC operations during copyback, and reducing or preventing error propagation associated with copyback operations as compared to prior systems and methods, among other benefits.

Embodiments can also provide benefits such increasing memory capacity of memory systems and/or reducing pin counts associated with memory system controllers as compared to prior systems.

In the following detailed description of the present disclosure, reference is made to the accompanying drawings that form a part hereof, and in which is shown by way of illustration how one or more embodiments of the disclosure may be practiced. These embodiments are described in sufficient detail to enable those of ordinary skill in the art to practice the embodiments of this disclosure, and it is to be understood that other embodiments may be utilized and that process, electrical, and/or structural changes may be made without departing from the scope of the present disclosure. As used herein, the designators “N,” and “M,” particularly with respect to reference numerals in the drawings, indicates that a number of the particular feature so designated can be included with one or more embodiments of the present disclosure. As used herein, “a number of” something can refer to one or more of such things.

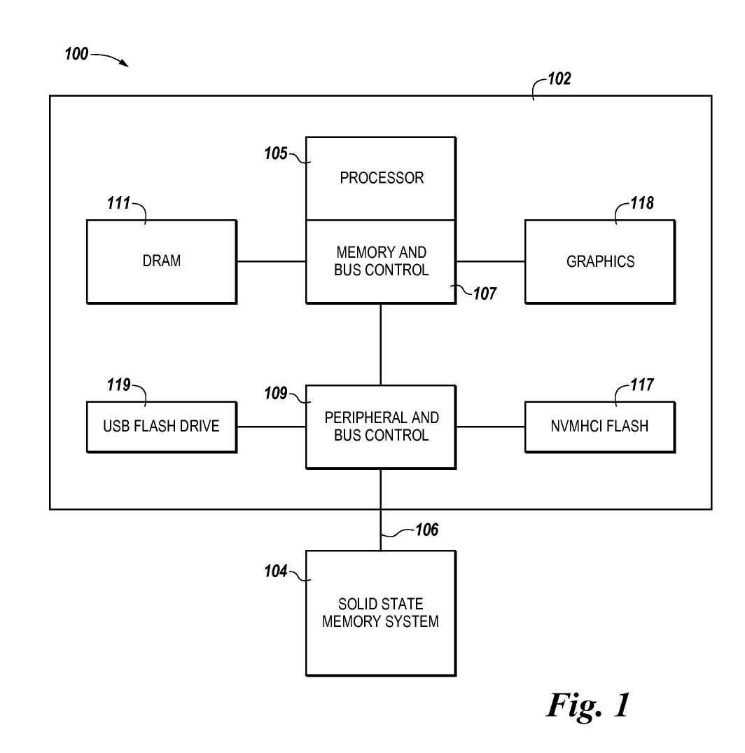

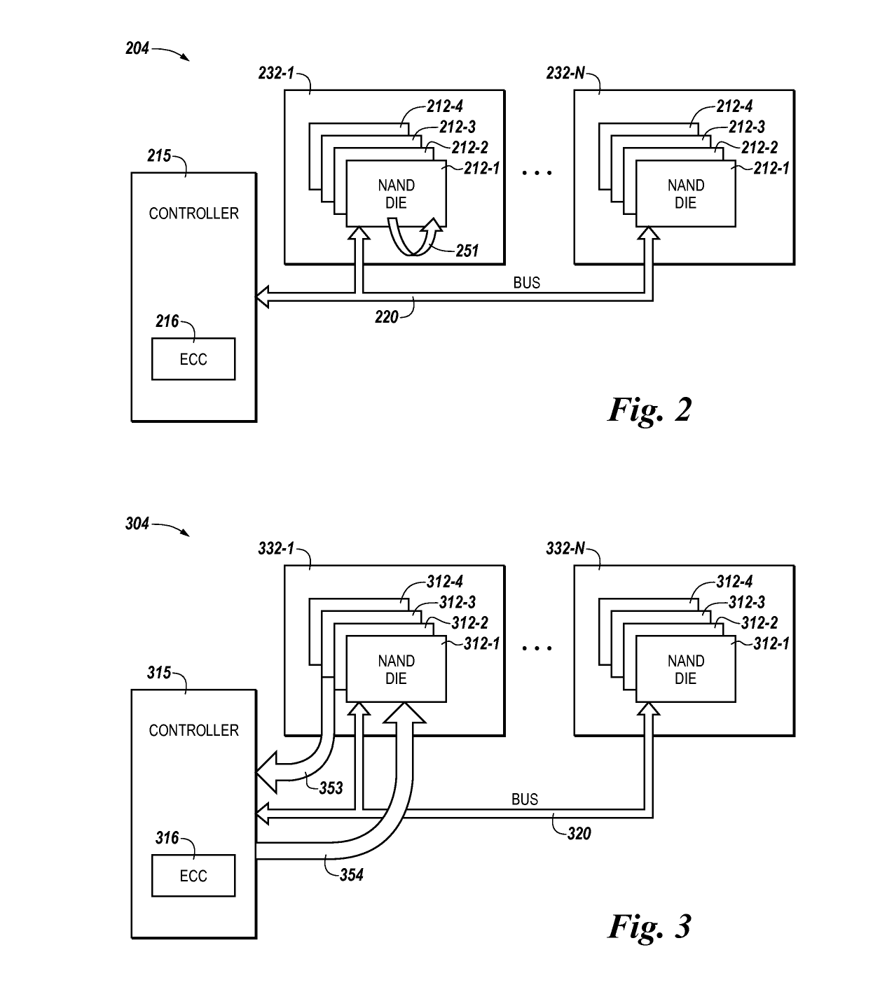

The figures herein follow a numbering convention in which the first digit or digits correspond to the drawing figure number and the remaining digits identify an element or component in the drawing. Similar elements or components between different figures may be identified by the use of similar digits. For example, 104 may reference element “04” in FIG. 1, and a similar element may be referenced as 204 in FIG. 2. As will be appreciated, elements shown in the various embodiments herein can be added, exchanged, and/or eliminated so as to provide a number of additional embodiments of the present disclosure. In addition, as will be appreciated, the proportion and the relative scale of the elements provided in the figures are intended to illustrate the embodiments of the present invention, and should not be taken in a limiting sense.

FIG. 1 is a functional block diagram of a computing system in accordance with one or more embodiments of the present disclosure. Computing system 100 includes a memory system 104, for example, one or more solid state drives (SSDs), communicatively coupled to host 102. Memory system 104 can be communicatively coupled to the host 102 through an interface 106, such as a backplane or bus, for instance.

Examples hosts 102 can include laptop computers, personal computers, digital cameras, digital recording and playback devices, mobile telephones, PDAs, memory card readers, and interface hubs, among other host systems. The interface 106 can include a serial advanced technology attachment (SATA), peripheral component interconnect express (PCIe), or a universal serial bus (USB), among other connectors and interfaces. In general, however, host interface 106 can provide an interface for passing control, address, data, and other signals between the memory system 104 and the host 102.

Host 102 can include one or more processors 105 (e.g., parallel processors, co-processors, etc.) communicatively coupled to a memory and bus control 107. The processor 105 can be one or more microprocessors, or some other type of controlling circuitry, such as one or more application-specific integrated circuits (ASICs), for example. Other components of the computing system 100 may also have processors. The memory and bus control 107 can have memory and other components directly communicatively coupled thereto, for example, dynamic random access memory (DRAM) 111, graphic user interface 118, or other user interface (e.g., display monitor, keyboard, mouse, etc.).

The memory and bus control 107 can also have a peripheral and bus control 109 communicatively coupled thereto, which in turn, can connect to a memory system, such as a flash drive 119 using a universal serial bus (USB) interface, a non-volatile memory host control interface (NVMHCI) flash memory 117, or the memory system 104. As the reader will appreciate, the memory system 104 can be used in addition to, or in lieu of, a hard disk drive (HDD) in a number of different computing systems. The computing system 100 illustrated in FIG. 1 is one example of such a system; however, embodiments of the present disclosure are not limited to the configuration shown in FIG. 1.

Enterprise solid state storage appliances are a class of memory systems that can currently be characterized by terabytes of storage and fast performance capabilities, for example 100 MB/sec, 100K inputs/outputs per second (IOPS), etc. According to one or more embodiments of the present disclosure, an enterprise solid state storage appliance can be configured using solid state drive (SSD) components. For example, with respect to FIG. 1, the memory system 104 may be an enterprise solid state storage appliance implemented using one or more component SSDs, the one or more SSDs being operated as a memory system by a memory system controller.

FIG. 2 is a block diagram of a portion of a memory system 204 that can perform copyback operations in accordance with the prior art. As one example, the memory system 204 can be a solid state drive (SSD). The memory system 204 includes a memory system controller 215 (e.g., memory control circuitry, firmware, and/or software) coupled to a number of memory devices 232-1, . . . , 232-N via a bus 220. In some embodiments, the memory system controller can be local to the host, local to the memory system, or distributed between the host and the memory system.

The bus 220 can send/receive various signals (e.g., data signals, control signals, and/or address signals) between the memory devices 232-1, . . . , 232-N and the system controller 215. Although the example illustrated in FIG. 2 includes a single bus 220, the memory system 204 can include a separate data bus (DQ bus), control bus, and address bus. The bus 220 can have various types of bus structures including, but not limited to, bus structures related to Open NAND Flash Interface (ONFI), Compact Flash Interface, Multimedia Card (MMC), Secure Digital (SD), CE-ATA, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

As illustrated in FIG. 2, the memory devices 232-1, . . . , 232-N can include a number of memory units 212-1, 212-2, 212-3, and 212-4 that provide a storage volume for the memory system 204. The memory units 212-1 to 212-4 can be dies or chips, which can be referred to as logical units (LUNs). As such, the memory devices 232-1, . . . , 232-N can be multi-chip packages (MCPs) that include a number of dies 212-1 to 212-4 (e.g., NAND dies in this example).

The memory units 212-1 to 212-4 can include one or more arrays of memory cells. In this example, the memory units 212-1 to 212-4 include flash arrays having a NAND architecture.

The system controller 215 includes a signal processing component 216. In this example the signal processing component is an error correction component 216 (e.g., an ECC engine), which can determine (e.g., detect) whether an amount of data (e.g., a page of data) includes bit errors and can correct a particular number of errors in the data. The number of bit errors correctable by the error correction component 216 can vary based on factors such as the type of ECC used and/or the complexity of the error correction circuitry, for example. As used herein, error correction can refer to data recovery including, but not limited to, error detection and/or correction. As such, data recovery operations performed by an error correction component such as error correction component 216 can include detection of bit errors and/or correction of bit errors associated with a page of data, among other operations associated with data recovery, for instance. Accordingly, signal processing component 216 can employ an error correction code (ECC) as part of data recovery performed by the component 216 and/or other data recovery components associated with a controller (e.g., 215).

Arrow 251 shown in FIG. 2 represents a copyback operation performed by the system 204. The copyback operation can be initiated via a copyback command to one of the memory devices 232-1, . . . , 232-N. The copyback operation 251 performed by system 204 includes moving data of a source page within a particular die (e.g., 212-1) to a target page within the same die (e.g., 212-1). That is, the copyback command associated with system 204 limits the source and target for copyback operations to the same die.

In this example, the copyback operation 251 is performed internally to a particular memory device (e.g., 232-1). For instance, the memory device 232-1 can include a page buffer (not shown) that can store a page of data corresponding to a copyback read operation, and the page of data can be reprogrammed from the buffer to the target page. As such, the data does not have to be written out to the system controller 215 via bus 220, which can save processing time, for example. However, a number of bit errors can occur in the data page during the copyback operation 251. Moreover, the number of bit errors associated with copyback operation 251 may reach or exceed the number of errors correctable by the error correction component 216.

FIG. 3 is a block diagram of a portion of a memory system 304 that can perform copyback operations in accordance with the prior art. The system 304 is similar to the system 204 described above in connection with FIG. 2. The memory system 304 includes a memory system controller 315 (e.g., memory control circuitry, firmware, and/or software) coupled to a number of memory devices 332-1, . . . , 332-N via a bus 320.

The memory devices 332-1, . . . , 332-N can include a number of memory units 312-1, 312-2, 312-3, and 312-4 that provide a storage volume for the memory system 304. The memory units 312-1 to 312-4 can be dies or chips, which can be referred to as logical units (LUNs). As such, the memory devices 332-1, . . . , 332-N can be multi-chip packages (MCPs) that include a number of dies 312-1 to 312-4 (e.g., NAND dies in this example). The system controller 315 includes an error correction component 316, which can determine whether a page of data includes bit errors and can correct a particular number of errors in the page of data.

Unlike the system 204 illustrated in FIG. 2, the system 304 can perform a copyback operation in which the source page and target page are located in different memory units 312-1, 312-2, 312-3, and 312-4 (e.g., different dies). In this example, arrow 353 represents a copyback read operation in which data from a source page located in die 312-3 is written to a buffer (not shown) local to (e.g., on) the controller 315 via bus 320. The controller 315 can error correct the data with error correction component 316. As illustrated by arrow 354, the data can then be transferred along bus 320 back to the target page located on die 312-1 during a copyback program operation. As such, the data page associated with the copyback operation can be error corrected, and the target page and source page can be located in different memory units 312-1, 312-2, 312-3, and 312-4 within the memory devices 332-1, . . . , 332-N.

However, because the copyback operation involves transferring data along bus 320 for both the copyback read and copyback program operations, the bus 320 is not available for performing other operations on other memory devices 332-1, . . . , 332-N of the system 304 during copyback.

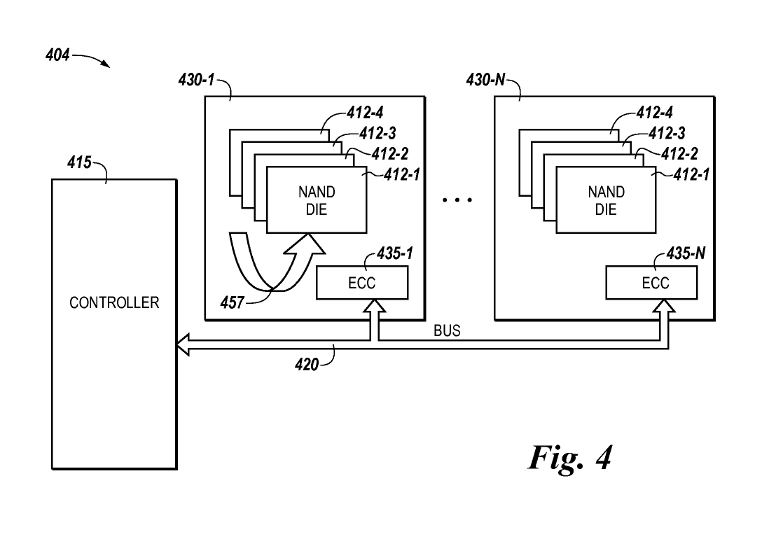

FIG. 4 is a block diagram of a portion of a memory system 404 that can perform copyback operations in accordance with one or more embodiments of the present disclosure. As one example, the memory system 404 can be a solid state drive (SSD). The memory system 404 includes a memory system controller 415 (e.g., memory control circuitry, firmware, and/or software) coupled to a number of memory devices 430-1, . . . , 430-N via a bus 420.

The bus 420 can send/receive various signals (e.g., data signals, control signals, and/or address signals) between the memory devices 430-1, . . . , 430-N and the system controller 415. Although the example illustrated in FIG. 4 includes a single bus 420, the memory system 404 can include a separate data bus (DQ bus), control bus, and address bus. The bus 420 can have various types of bus structures including, but not limited to, bus structures related to Open NAND Flash Interface (ONFI), Compact Flash Interface, Multimedia Card (MMC), Secure Digital (SD), CE-ATA, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

As illustrated in FIG. 4, the memory devices 430-1, . . . , 430-N can include a number of memory units 412-1, 412-2, 412-3, and 412-4 that provide a storage volume for the memory system 404. The memory units 412-1 to 412-4 can be dies or chips, which can be referred to as logical units (LUNs). As such, the memory devices 430-1, . . . , 430-N can be multi-chip packages (MCPs) that each include a number of dies 412-1 to 412-4 (e.g., NAND dies in this example). Embodiments of the present disclosure are not limited to the example shown in FIG. 4. For instance, memory systems in accordance with embodiments of the present disclosure can include more or less than four memory units (e.g., die) per memory device (e.g., MCP) and are not limited to a particular memory array architecture (e.g., NAND flash, NOR flash, DRAM, etc.).

In contrast to the systems 204 and 304 described in FIGS. 2 and 3, respectively, each of the memory devices 430-1, . . . , 430-N of system 404 includes a signal processing component such as an error correction component 435-1, . . . , 435-N (e.g., a component employing ECC functionality) that can be used for error correction in association with copyback operations and other operations (e.g., read, program, erase, etc.). Although not illustrated in FIG. 4, the error correction components 435-1, . . . , 435-N can be located in controllers local to the respective memory devices 430-1, . . . , 430-N, which are referred to herein as “device controllers.” The device controllers of the memory devices 435-1, . . . , 435-N can be coupled to system controller 425 via bus 420 and can control operations performed on the memory units 412-1 to 412-4. The local memory device controllers and/or the error correction components 435-1, . . . , 435-N can include one or more data buffers (e.g., page buffers) that can store data in association with copyback and other memory operations associated with system 404.

In the embodiment illustrated in FIG. 4, arrow 457 represents a copyback operation performed by the system 404. A copyback operation (e.g., 457) can be initiated via a copyback command sent from the system controller 415 to one or more of the memory devices 430-1, . . . , 430-N via bus 420. The copyback operation 457 performed by system 404 includes moving data of a source page within a particular memory unit (e.g., 412-1 to 412-4) to a target page within one of the memory units 412-1 to 412-4.

Copyback operations performed in system 404 remove restrictions as compared to previous systems such as system 204 shown in FIG. 2, such that the source and target (e.g., destination) for copyback operations are not limited to a same memory unit 412-1 to 412-4 (e.g., die). That is, the source data page corresponding to a copyback read operation need not be from the same memory unit 412-1 to 412-4 to which the target page is programmed as part of the corresponding copyback program operation.

Since the error correction components 435-1, . . . , 435-N are local to (e.g., located within) the respective memory devices 430-1, . . . , 430-N (e.g., as opposed to within the system controller 415), error correction associated with copyback operations can be performed locally within the memory devices 430-1, . . . , 430-N. Performing error correction functions locally within the memory devices 430-1, . . . , 430-N can provide benefits such as reducing the load on the bus 420 during copyback operations, reducing the time used for error correction operations (e.g., ECC operations) during copyback, and reducing or preventing error propagation associated with copyback operations as compared to prior systems and methods, among other benefits.

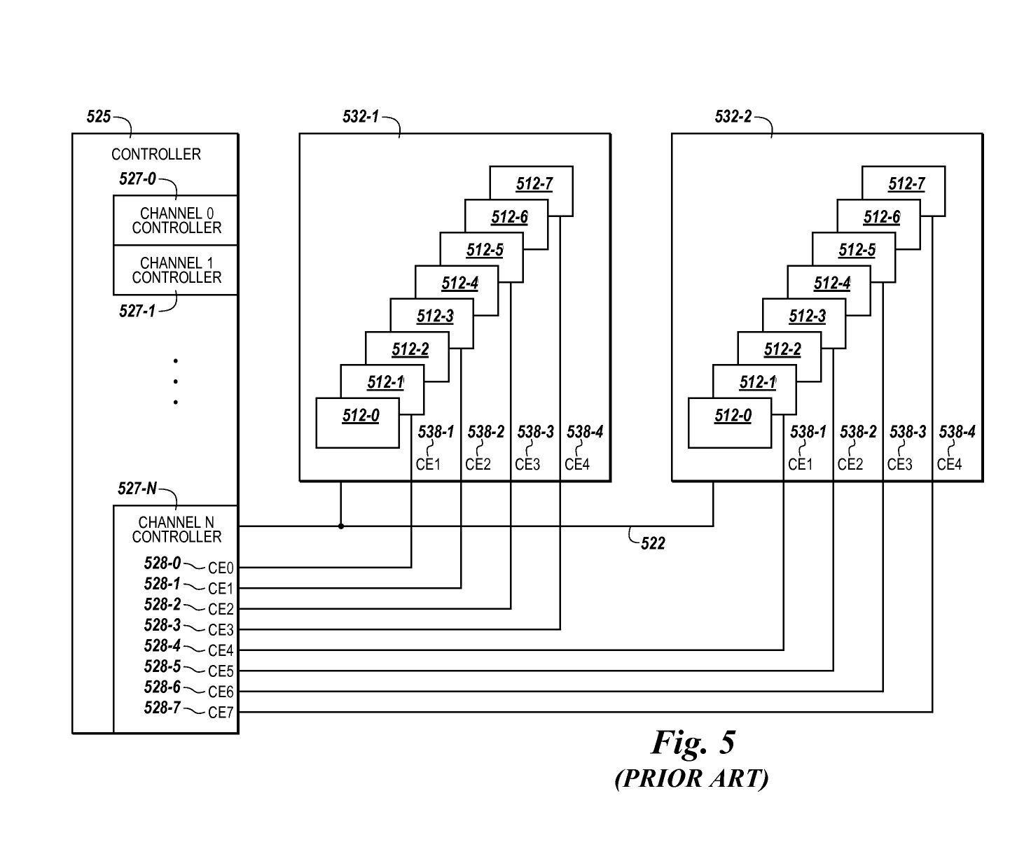

FIG. 5 is a block diagram of a portion of a memory system in accordance with prior art. The memory system illustrated in FIG. 5 includes a system controller 525. The system controller 525 can control access across a number of memory channels. In this example, the controller 525 includes a number of channel controllers 527-0, 527-1, . . . , 527-N each controlling access to a respective memory channel.

In the example shown in FIG. 5, the channel controller 527-N is coupled to a first memory device 532-1 and a second memory device 532-2 via a bus 522 (e.g., a data and control bus). Each of the memory devices 532-1 and 532-2 includes 8 memory units 512-0 to 512-7. The memory units 512-0 to 521-7 can be memory die and the memory devices 532-1 and 532-2 can be multi-chip packages, as an example. In this example, each of the memory devices 532-1 and 532-2 include four chip enable (CE) pins 538-1 (CE1), 538-2 (CE2), 538-3 (CE3), and 538-4 (CE4) that receive CE signals from the channel controller 527-N. As such, the system controller 525 includes eight CE pins dedicated to providing the CE signals to the memory devices 532-1 and 532-2. Although not shown in FIG. 5, each of the channel controllers 527-0 to 527-N can be coupled to a number of memory devices (e.g., two in this example). As such, if the system controller 525 includes 32 channels with each channel corresponding to two memory devices, then the total number of CE pins would be 256.

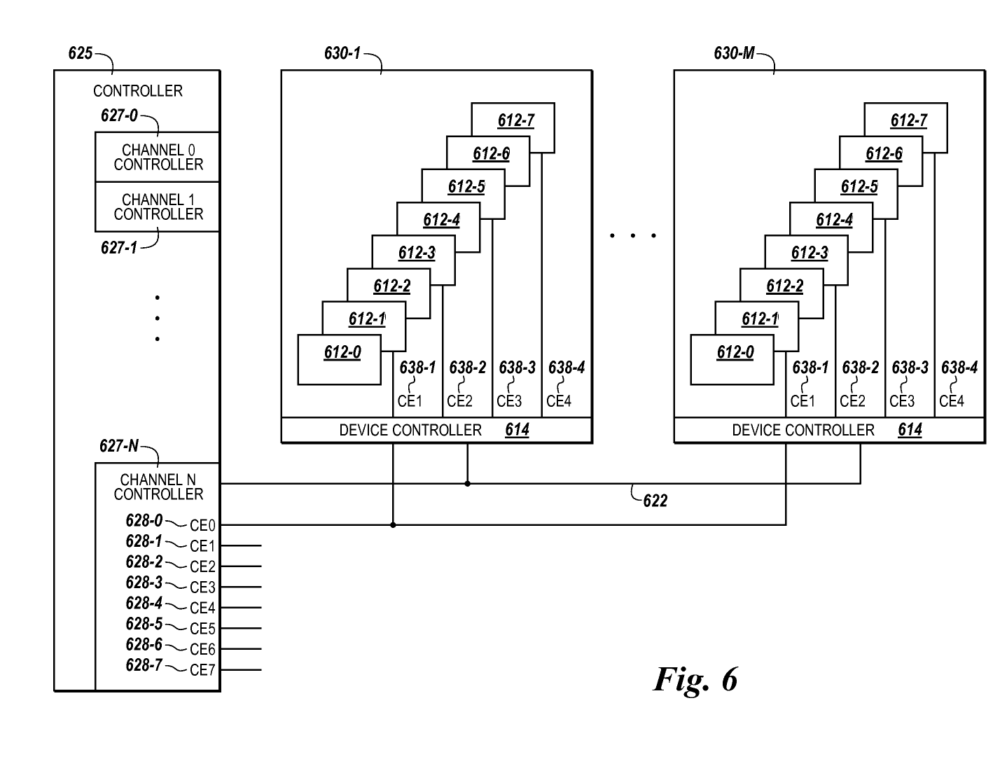

FIG. 6 is a block diagram of a portion of a memory system in accordance with one or more embodiments of the present disclosure. The embodiment illustrated in FIG. 6 can provide reduced pin counts as compared to previous memory systems such as that described above in connection with FIG. 5. The memory system illustrated in FIG. 6 includes a system controller 625. The system controller 625 can control access across a number of memory channels. In this example, the controller 625 includes a number of channel controllers 627-0, 627-1, . . . , 627-N each controlling access to a respective memory channel.

In the example shown in FIG. 6, the channel controller 627-N is coupled to a number of memory devices 630-1, . . . , 630-M via a bus 622 (e.g., a data and control bus). In this embodiment, each of the memory devices 630-1, . . . , 630-M includes 8 memory units (e.g., die) 612-0 to 612-7. The memory devices 630-1, . . . , 630-M can be multi-chip packages, as an example. In the system illustrated in FIG. 6, the memory devices 630-1, . . . , 630-M each include a device controller 614. The device controller 614 can perform various operations on the memory units 612-0 to 612-7 of the memory devices 630-1, . . . , 630-M in response to signals from the system controller 625.

In this example, each of the memory devices 630-1, . . . , 630-M include four chip enable (CE) pins 638-1 (CE1), 638-2 (CE2), 638-3 (CE3), and 638-4 (CE4) that receive CE signals from the channel controller 627-N. However, unlike in the example illustrated in FIG. 5, a single CE signal (e.g., 628-0) from the system controller 625 is shared by the number of memory devices 630-1, . . . , 630-M corresponding to the particular memory channel (e.g., channel N). As such, the remaining CE pins (e.g., 628-1 to 628-7) associated with channel controller 627-N can be used for other purposes or eliminated in order to reduce the total pin count associated with the system controller 625. For instance, as compared to the example illustrated in FIG. 5, the system controller 625 would include 32 CE pins (e.g., one CE pin for each of 32 channels) instead of 256 CE pins (e.g., eight for each of 32 channels).

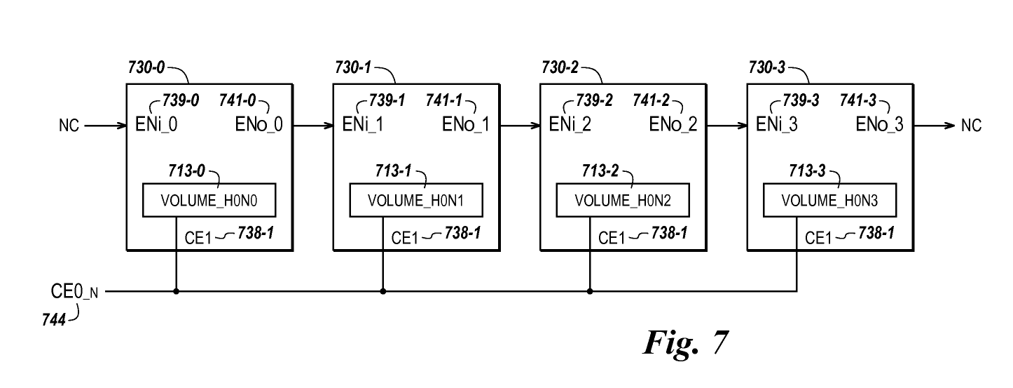

FIG. 7 is a block diagram of a portion of a memory system in accordance with one or more embodiments of the present disclosure. The embodiment illustrated in FIG. 7 includes a number of memory devices 730-0, 730-1, 730-2, and 730-3 and illustrates an example topology for pin reduction in accordance with one or more embodiments of the present disclosure. The memory devices 730-0, 730-1, 730-2, and 730-3 can be memory devices such as devices 730-1 to 730-M shown in FIG. 7. As an example, the memory devices 730-0, 730-1, 730-2, and 730-3 can be NAND memory devices.

In the example illustrated in FIG. 7, each of the devices 730-0, 730-1, 730-2, and 730-3 includes an enable input pin 739 and an enable output pin 741. For instance, device 730-0 includes enable input pin 739-0 (ENi_0) and enable output pin 741-0 (ENo_0), device 730-1 includes enable input pin 739-1 (ENi_1) and enable output pin 741-1 (ENo_1), device 730-2 includes enable input pin 739-2 (ENi2) and enable output pin 741-2 (ENo_2), and device 730-3 includes enable input pin 739-3 (ENi_3) and enable output pin 741-3 (ENo_3).

As illustrated, a daisy chain configuration can be created between the memory devices 730-0, 730-1, 730-2, and 730-3. In this example, the enable input pin 739-0 of device 730-0 and the enable output pin 741-3 of device 730-3 are not connected (NC). The enable input pins 739 of the other devices are connected to the enable output pin 741 of the previous device in a daisy chain configuration as shown in FIG. 7.

As illustrated in FIG. 7, and as described above in connection with FIG. 6, each of the memory devices 730-0, 730-1, 730-2, and 730-3 share a common CE pin from a system controller (e.g., system controller 625 shown in FIG. 6). For instance, chip enable pin 744 (CEO_n) is shared by the chip enable pin 738-1 (CE1) of each of the memory devices 730-0, 730-1, 730-2, and 730-3. The CE1 pin of each of the memory devices 730-0, 730-1, 730-2, and 730-3 is associated with (e.g., corresponds to) a particular target volume 713-0, 713-1, 713-2, 713-3. A target volume can refer to a number of memory units (e.g., die or LUNs) that share a particular CE signal within a memory device. Each of the target volumes can be assigned a volume address. In this example, target volume 713-0 is assigned volume address H0N0, target volume 713-1 is assigned volume address H0N1, target volume 713-2 is assigned volume address H0N2, and target volume 713-3 is assigned volume address H0N3. In one or more embodiments, the volume addresses can be assigned to particular target volumes upon initialization of the memory system.

In operation, the state of the enable input pins 739-0, 739-1, 739-2, and 739-3 determines whether the respective memory device 730-0, 730-1, 730-2, and 730-3 is able to accept commands. For example, if the enable input pin of a particular device is high and the CE pin 738-1 of the device is low, then the particular device can accept commands. If the enable input of the particular device is low or the CE pin 738-1 is high, then the device cannot accept commands. A volume select command can be issued by the system controller in order to select a particular target volume (e.g., 713-0, 713-1, 713-2, 713-3) coupled to a particular CE pin 744 of the system controller. In this manner, volume addressing can be used to access target volumes of the memory devices 730-0, 730-1, 730-2, and 730-3.

Embodiments of the present disclosure are not limited to the topology illustrated in FIG. 7. For instance, embodiments are not limited to a daisy chain topology.

### CONCLUSION

The present disclosure includes methods, devices, memory controllers, and systems for performing copyback operations. One or more methods include reading data from a first memory unit of a memory device responsive to a copyback command, performing signal processing on the data using a signal processing component local to the memory device, and programming the data to a second memory unit of the memory device.

It will be understood that when an element is referred to as being “on,” “connected to” or “coupled with” another element, it can be directly on, connected, or coupled with the other element or intervening elements may be present. In contrast, when an element is referred to as being “directly on,” “directly connected to” or “directly coupled with” another element, there are no intervening elements or layers present. As used herein, the term “and/or” includes any and all combinations of one or more of the associated listed items. As used herein the term “or,” unless otherwise noted, means logically inclusive or. That is, “A or B” can include (only A), (only B), or (both A and B). In other words, “A or B” can mean “A and/or B” or “one or more of A and B.”

Although specific embodiments have been illustrated and described herein, those of ordinary skill in the art will appreciate that an arrangement calculated to achieve the same results can be substituted for the specific embodiments shown. This disclosure is intended to cover adaptations or variations of one or more embodiments of the present disclosure. It is to be understood that the above description has been made in an illustrative fashion, and not a restrictive one. Combination of the above embodiments, and other embodiments not specifically described herein will be apparent to those of skill in the art upon reviewing the above description. The scope of the one or more embodiments of the present disclosure includes other applications in which the above structures and methods are used. Therefore, the scope of one or more embodiments of the present disclosure should be determined with reference to the appended claims, along with the full range of equivalents to which such claims are entitled.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A method for performing a copyback operation, comprising:
reading data from a first memory unit of a memory device responsive to a copyback command;
performing signal processing on the data using a signal processing component local to the memory device; and
programming the data to a second memory unit of the memory device.

2. The method of claim 1, including storing the data read from the first memory unit in a page buffer local to the memory device.

3. The method of claim 1, including providing the copyback command to the memory device via a bus coupled between the memory device and a system controller.

4. The method of claim 3, including performing a number of memory operations on at least one different memory device coupled to the system controller while the copyback operation is being performed.

5. The method of claim 1, wherein performing signal processing on the data using a signal processing component includes performing an error correction operation using an error correction component located in a controller local to the memory device.

6. The method of claim 5, including providing the copyback command to the controller local to the memory device via a bus coupled between the memory device and a system controller.

7. The method of claim 1, wherein programming the data to a second memory unit includes programming the data to a memory unit other than the first memory unit.

8. A method for performing a copyback operation, comprising:
moving data of a source page of a memory unit of a memory device to a target page of a different memory unit of the memory device; and
performing signal processing on the data using a signal processing component local to the memory device prior to moving the data to the target page.

9. The method of claim 8, including performing the copyback operation without moving the data from the memory unit to a system controller.

10. The method of claim 8, including moving the data of the source page to the target page responsive to a copyback command provided to the memory device via a bus coupled between the memory device and a system controller.

11. The method of claim 10, wherein the memory device is one of a number of memory devices coupled to the system controller via the bus, and wherein the method includes performing one or more memory operations on memory units of the number of memory devices while the copyback operation performed.

12. The method of claim 11, wherein performing one or more memory operations includes performing at least one of a program operation and a read operation.

13. A memory device, comprising:
a number of memory units; and
a controller coupled to the number of memory units and configured to:
store data read from a first memory unit of the memory device in association with a copyback read operation;
perform signal processing on the data using a signal processing component of the memory device; and
move the data to a second memory unit of the memory device in association with a copyback program operation.

14. The memory device of claim 13, including a page buffer; and wherein the controller being configured to store data comprises the controller being configured to store the data read from the first memory unit in the page buffer.

15. The memory device of claim 13, wherein the first memory unit is different than the second memory unit.

16. The memory device of claim 15, wherein the first and the second memory units are NAND die.

17. The memory device of claim 16, wherein the memory device is a multi-chip package.

18. The memory device of claim 13, wherein the controller is configured to read the page of data from a source page of the first memory unit and move the page of data to a target page of the second memory unit.

19. A memory system, comprising:
a number of memory devices each having a number of memory units and a component configured to perform signal processing on a respective page of data in association with a respective copyback operation; and
a system controller coupled to the number of memory devices;

20. The memory system of claim 19, wherein the memory devices each include a device controller configured to read the respective page of data from a first memory unit of the respective memory device responsive to the respective copyback command.

21. The memory system of claim 20, wherein each of the device controllers is configured to program the respective page of data to a second memory unit of the respective memory device subsequent to the signal processing.

22. The memory system of claim 21, wherein each of the device controllers is configured to store the respective page of data in a page buffer local to the respective memory device prior to programming the respective page of data to the respective second memory unit.

23. The memory system of claim 19, wherein the system controller is configured to initiate operations other than a copyback operation on the number of memory devices while the copyback operation is being performed.

24. The memory system of claim 19, wherein each of the signal processing components includes an error correction component.

25. The memory system of claim 19, wherein the number of memory devices are multi-chip packages and wherein the number of memory units are NAND flash memory units.

26. A memory controller local to a memory device and comprising:
an interface to couple the memory controller to a system controller; and
a signal processing component;
wherein the memory controller is configured to:
move data of a source page of a first memory unit of the memory device to a target page of a second memory unit of the memory device; and
perform a signal processing operation on the data using the signal processing component prior to moving the data to the target page.

27. The memory controller of claim 26, wherein the memory controller is configured to store the data in a page buffer local to the memory device prior to moving the data to the target page.

28. The memory controller of claim 26, wherein the memory controller is configured to move the data responsive to a copyback command received from the system controller.

29. The memory controller of claim 28, wherein the signal processing component includes an ECC component.

30. The memory controller of claim 28, wherein the memory controller is configured to move the data of the source page of the first memory unit of the memory device to the target page of the second memory unit of the memory device without moving the data from the memory unit to the system controller.

31. A memory controller local to a memory device and comprising:
an interface to couple the memory controller to a system controller; and
a signal processing component;
wherein the memory controller is configured to:
read a page of data from a first memory unit of the memory device responsive to a copyback command;
perform signal processing on the page of data using the signal processing component; and
program the page of data to a second memory unit of the memory device.

32. The memory controller of claim 31, wherein the memory controller is configured to read the page of data from the first memory unit, perform the signal processing on the page of data, and program the page of data to the second memory unit without moving the data to the system controller.

33. The memory controller of claim 31, wherein the signal processing component includes an error correction component and wherein the memory controller is configured to perform an error correction operation on the page of data using the error correction component.
